(19) United States
(12) Patent Application Publication
(10) Pub. No.: US 2019/0025518 A1
(43) Pub. Date: Jan. 24, 2019

(54) SEMICONDUCTOR DEVICE

(71) Applicant: SAMSUNG ELECTRONICS CO., LTD., Suwon-si (KR)

(72) Inventors: Ho Chul JI, Seongnam-si (KR); Keun Yeong CHO, Suwon-si (KR)

(21) Appl. No.: 15/883,491

(22) Filed: Jan. 30, 2018

(30) Foreign Application Priority Data
Jul. 19, 2017 (KR) 10-2017-0091348

(51) Int. Cl. G02B 6/30; G02B 6/293; G02B 6/34; G02B 6/12

(52) U.S. Cl. CPC G02B 6/30; G02B 6/29361; G02B 2006/12102; G02B 6/12; G02B 2006/12104; G02B 6/34

(57) ABSTRACT

A semiconductor device includes a first device and a second device. The first device includes at least one waveguide on a first substrate. The second device is on the first device and includes at least one optical fiber on an upper surface of a second substrate, a reflector on the upper surface of the second substrate, and a lens on a lower surface of the second substrate below the reflector. The at least one waveguide to carry light from the reflector and passing through the lens for output to the optical fiber.

### CROSS-REFERENCE TO RELATED APPLICATION

Korean Patent Application No. 10-2017-0091348, filed on Jul. 19, 2017, and entitled, “Semiconductor Device,” is incorporated by reference herein in its entirety.

### BACKGROUND

### 1. Field

One or more embodiments described herein relate to a semiconductor device.

### 2. Description of the Related Art

Demand for the high-speed transmission and reception of large amounts of data in electronic devices has increased. Limitations on transmission speed may largely be attributed to transmission of electrical signals through metal wirings. Various approaches have been proposed to replace the electrical signals with optical signals. Such an approach requires certain components, e.g., light sources, waveguides, and optical fibers. However, misalignment of these and other components may introduce errors and inefficiencies.

### SUMMARY

In accordance with one or more embodiments, a semiconductor device includes a first device including at least one waveguide on a first substrate; and a second device on the first device and including at least one optical fiber on an upper surface of a second substrate, a reflector on the upper surface of the second substrate, and a lens on a lower surface of the second substrate below the reflector, the at least one waveguide to carry light from the reflector and passing through the lens for output to the optical fiber.

In accordance with one or more other embodiments, a semiconductor device includes a light source to emit light; at least one light modulator to generate an optical signal based on light emitted by the light source; at least one waveguide, connected to the at least one light modulator, to provide a path for the optical signal; an optical fiber to output the optical signal; and a reflector to reflect the optical signal emitted along the at least one waveguide for input into the optical fiber, wherein the at least one light modulator and the at least one waveguide are on a first substrate and wherein the optical fiber and the reflector are on a second substrate different from the first substrate.

In accordance with one or more other embodiments, a semiconductor device includes an optical fiber to receive an optical signal; a reflector to reflect the optical signal emitted through the optical fiber; at least one waveguide to receive the optical signal reflected by the reflector and provide a path for the optical signal; and a photodetector, connected to the at least one waveguide, to convert the optical signal to an electrical signal, wherein the photodetector and the at least one waveguide are on a first substrate and wherein the optical fiber and the reflector are on a second substrate different from the first substrate.

### BRIEF DESCRIPTION OF THE DRAWINGS

Features will become apparent to those of ordinary skill in the art by describing in detail exemplary embodiments with reference to the attached drawings in which:

FIG. 1A illustrates an embodiment of a semiconductor device, and FIG. 1B illustrates an embodiment of a semiconductor device;

FIG. 2 illustrates another embodiment of a semiconductor device;

FIGS. 3 to 15 illustrate additional embodiments of a semiconductor device;

FIG. 16 illustrates another embodiment of a semiconductor device;

FIGS. 17 to 22 illustrate additional embodiments of a semiconductor device; and

FIG. 23 illustrates an embodiment of an electronic device.

### DETAILED DESCRIPTION

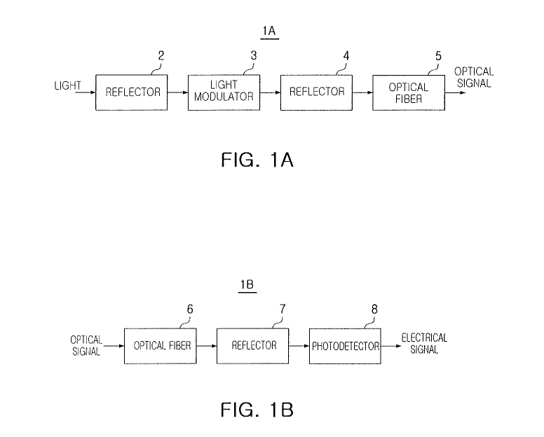

FIG. 1A illustrates an embodiment of a semiconductor device 1A which may include reflectors 2 and 4, a light modulator 3, and an optical fiber 5. One or more waveguides may be provided on a path on which light is transmitted to the optical fiber 5 through the reflectors 2 and 4 and the light modulator 3. For example, light may be incident on the optical fiber 5 via the reflectors 2 and 4 and the light modulator 3 through the waveguide.

In an example embodiment, the reflectors 2 and 4 and the optical fiber 5 may be on a substrate, which is different from a substrate of the light modulator 3. After the light modulator 3 is placed on a first substrate and the reflectors 2 and 4 and the optical fiber 5 are placed on a second substrate different from the first substrate, the semiconductor device 1A may be formed by coupling the first substrate to the second substrate using an alignment key on each of the first substrate and the second substrate. The alignment keys allow paths of light on first substrate and the second substrate to be aligned.

Light may be generated by a light source (e.g., a laser diode or a light emitting diode (LED)) and may be reflected by the reflector 2 to be incident on the light modulator 3. The light modulator 3 may convert a predetermined electrical signal to an optical signal and may be connected to pads to receive an electrical signal from an external source. The light modulator 3 may change the phase, intensity, and/or another parameter of the light based on the electrical signal input through the pads.

The light modulator 3 may be, for example, an electro-absorption modulator or an interference-type modulator. In an example embodiment, the light modulator 3 may be a Mach-Zehnder interferometer-type modulator which divides light received by the reflector 2 into two paths. The phase of light on at least one of the two paths may be modulated, and offsetting and constructive interference occurs between phase-modulated light and phase-intact light. In another example embodiments, the light modulator 3 may be another type of interference-type modulator or electro-absorption modulator.

Light modulated by reflecting an electrical signal input to the light modulator 3 may be reflected by the reflector 4 to be incident on the optical fiber 5. Light incident on the optical fiber 5 may be output outwardly of the semiconductor device 1A. Thus, the semiconductor device 1A illustrated in FIG. 1A may be provided as an optical signal transmitting device that modulates light according to an electrical signal input to the light modulator 3, generates an optical signal, and outputs the optical signal through the optical fiber 5.

FIG. 1B illustrates another embodiment of a semiconductor device 1B which may be provided as an optical signal receiving device, in which the reflector 7 reflects an optical signal input through the optical fiber 6 and transmits the optical signal to a photodetector 8. In an example embodiment, a waveguide may be provided on a path on which the optical signal is incident through the optical fiber 6, and the optical signal is transmitted to the photodetector 8 through the reflector 7.

In an example embodiment, the optical fiber 6 and the reflector 7 may be provided on a substrate different from a substrate on which the photodetector 8 is provided. In an example embodiment, after the photodetector 8 is formed on the first substrate and the optical fiber 6 and the reflector 7 are formed on the second substrate different from the first substrate, the semiconductor device 1B may be manufactured by coupling the first substrate to the second substrate using alignment keys on each of the first substrate and the second substrate. Performing the coupling process based on the alignment keys aligns the paths of light on the first substrate and the second substrate.

The photodetector 8 may include at least one optoelectronic device (e.g., a photodetector) that converts an optical signal to an electrical signal. The photodetector 8 may be connected to pads that output an electrical signal generated by converting an optical signal. In an example embodiment, an electrical signal which is generated by converting an optical signal by the photodetector 8 may be provided as a signal corresponding to an electrical signal input to the light modulator 3.

Thus, the semiconductor device 1A of FIG. 1A may be on a transmission side of the electrical signal and the semiconductor device 1B of FIG. 1B may be on a reception side of the electrical signal. As a result, communications using optical wiring between a transmission module and a reception module may be implemented.

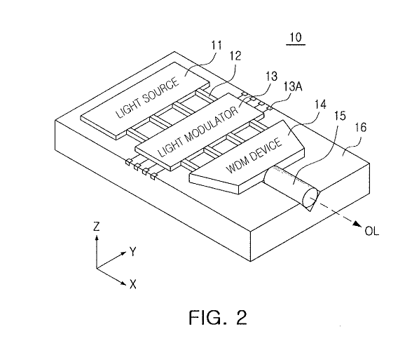

FIG. 2 illustrates another embodiment of a semiconductor device 10 serving as an optical signal transmitting device that converts an electrical signal to an optical signal for output. With reference to FIG. 2, the semiconductor device 10 may include a light source 11, a light modulator 13, a wavelength division multiplexing (WDM) device 14, and an optical fiber 15. One or more waveguides 12 may be between the light source 11, the light modulator 13, the WDM device 14, and the optical fiber 15, as a path of light. In an example embodiment, at least a portion of the light source 11, the waveguide 12, the light modulator 13, the WDM device 14, and the optical fiber 15 may be encapsulated by an insulating layer on a substrate 16.

With reference to FIG. 2, light generated in the light source 11 may be transmitted to the light modulator 13 through the waveguide 12. In an example embodiment, the light source 11 may include a plurality of light sources generating light of different wavelengths. Light generated in each of a plurality of light sources may be transmitted to the light modulator 13 through different waveguides 12.

The light modulator 13 may also include a plurality of light modulators for modulating light of different wavelengths. In an example embodiment, the number of light sources in the light source 11 may be equal to the number of light modulators in the light modulator 13. The light modulators may generate an optical signal by changing the phase, intensity, and/or another parameter of light generated by the light source 11 based on an electrical signal input through a pad 13A electrically connected to the light modulator 13. The optical signal generated by each of the light modulators may be input to the WDM device 14.

The WDM device 14 may receive optical signals in different wavelength bands to generate a single output optical signal OL. For example, the WDM device 14 may function as a type of multiplexer. The output optical signal OL generated by the WDM device 14 may be output through the optical fiber 15. In an example embodiment, the optical fiber 15 may be in a V-shaped groove in the substrate 16.

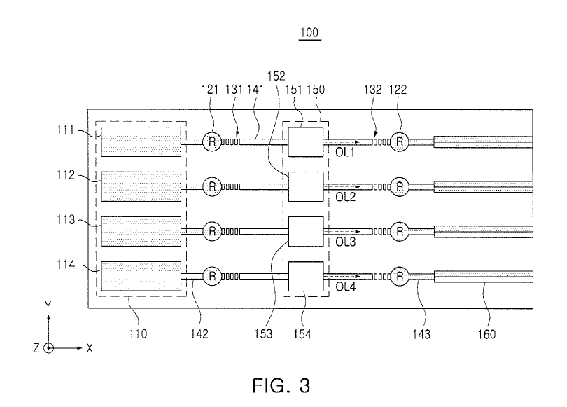

FIGS. 3 to 15 illustrate additional embodiments of a semiconductor device.

With reference to FIG. 3, a semiconductor device 100 may include a light source 110, reflectors 121 and 122, a light modulator 150, and optical fibers 160. Waveguides 141 to 143 may be between adjacent ones of the light source 110, the reflectors 121 and 122, the light modulator 150, and the optical fibers 160, thereby providing a light path. The light source 110 may include a first light source 111, a second light source 112, a third light source 113, and a fourth light source 114 emitting light of different wavelengths. The light modulator 150 may include a first light modulator 151, a second light modulator 152, a third light modulator 153, and a fourth light modulator 154 for changing an intensity, a phase, and/or another parameter of light having different wavelengths in order to generate corresponding optical signals. The number of light sources 111 to 114 and the number of light modulators 151 to 154 may be the same or different among different embodiments.

In an example embodiment, light generated in each of the first light source 111, the second light source 112, the third light source 113, and the fourth light source 114 may be output to respective ones of the first light modulator 151, the second light modulator 152, the third light modulator 153, and the fourth light modulator 154 in order to generate optical signals. The first light modulator 151, the second light modulator 152. the third light modulator 153, and the fourth light modulator 154 may receive electrical signals from an external source and generate a first optical signal OL1, a second optical signal OL2, a third optical signal OL3, and a fourth optical signal OL4, respectively, based on the electrical signals. The first optical signal OL1, the second optical signal OL2, the third optical signal OL3, and the fourth optical signal OL4 may transmit different data and information to be outwardly output through corresponding optical fibers 160. The optical fibers 160 may be arranged in parallel. The first optical signal OL1, the second optical signal OL2, the third optical signal OL3, and the fourth optical signal OL4 may be output through the plurality of optical fibers 160, respectively, without interference or overlap therebetween.

In the example embodiment of FIG. 3, components 110, 142, 143, and 160 (marked by hatching) may be formed on a substrate different from a substrate on which the remainder of components 131, 141, and 150 (not marked by hatching) are disposed. In an example embodiment, a path of light provided by the waveguides 142 and 143 (marked by hatching) may be coupled to a path of light provided by a waveguide 141 (not marked by hatching) by reflectors 121 and 122 and grating couplers 131 and 132.

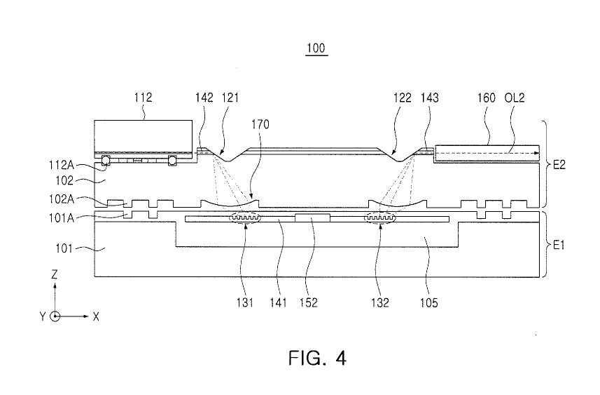

FIG. 4 illustrates a cross-sectional view of the semiconductor device 100 taken in a direction perpendicular to light passing through a second light source 112 and a second light modulator 152.

With reference to FIG. 4, the semiconductor device 100 may include a second device E2 on a first device E1. The first device E1 may include a lower waveguide 141 on a first substrate 101. In an example embodiment, the lower waveguide 141 may be encapsulated in the insulating layer 105. A first grating coupler 131 and a second grating coupler 132 may be on opposing ends of the lower waveguide 141.

The second device E2 may include a second light source 112 and an optical fiber 160 on the second substrate 102, and reflectors 121 and 122 may be adjacent to a light source 110 and the optical fiber 160. The second light source 112 may be connected to the second substrate 102 using flip chip bonding or another method. Light generated by the second light source 112 may be passed through the first upper waveguide 142 and reflected by the first reflector 121 toward and onto the first grating coupler 131.

The first reflector 121 may be above the first grating coupler 131. The first reflector 121 may be formed in such a manner that upper waveguides 142 and 143 are in the second substrate 102, and an area of the second substrate 102 is removed from an upper surface of the second substrate 102 to form a V-shaped groove. Thus, as illustrated in FIG. 4, an upper waveguide may remain between the first reflector 121 and a second reflector 122.

In an example embodiment, a lens 170 may be formed on a lower surface of the second substrate 102 so that light reflected by the first reflector 121 may be effectively incident on the first grating coupler 131. The lens 170 may be provided as a convex lens between the first reflector 121 and the first grating coupler 131.

Light incident on the first grating coupler 131 may be emitted through the lower waveguide 141 and transmitted to a second light modulator 152. The second light modulator 152 may modulate a phase, an intensity, and/or another parameter of light, thereby generating a second optical signal OL2. The second optical signal OL2 may be output outwardly of the lower waveguide 141 through the second grating coupler 132 and may be reflected by the second reflector 122 toward and incident on the optical fiber 160 through a second upper waveguide 143. In order to secure a path of the second optical signal OL2, the second reflector 122 may be above the second grating coupler 132.

With reference to FIG. 4, a first alignment structure 101A may be on an upper surface of the first substrate 101 and a second alignment structure 102A may be on the lower surface of the second substrate 102. The first alignment structure 101A and the second alignment structure 102A may be aligned with each other in order to align the first device E1 with the second device E2. This alignment allows a light transmission path between the first device E1 and the second device E2 to be precisely aligned.

Thus, in an example embodiment, components of the first device E1 and the second device E2 for implementing a light transmitting device may be provided in the first substrate 101 and the second substrate 102 that are separately provided. A light transmitting device may therefore be manufactured by combining the first device E1 and the second device E2. During the manufacturing process, an alignment process may be performed using alignment structures 101A and 102A in the first device E1 and the second device E2, respectively. The alignment structures allows the time and cost for forming the light emitting device to be reduced. Also, a test process for testing an alignment state of the first and second devices E1 and E2 may be simplified.

Thicknesses of the first substrate 101 and the second substrate 102 and a form of the lens 170 may be determined, for example, according to the focal distance between the first device E1 and the second device E2. In some cases, obtaining an accurate focal distance may be difficult to secure by only adjusting the thicknesses of the first substrate 101 and the second substrate 102 and the form of the lens 170. For this reason, in some embodiments, a separate device may therefore be inserted between the first device E1 and the second device E2.

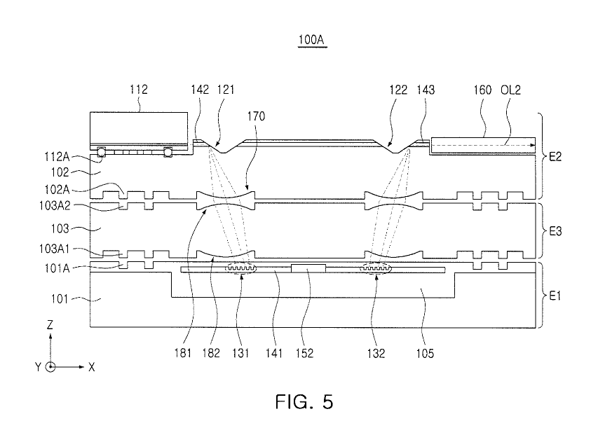

FIG. 5 illustrates an embodiment of a semiconductor device 100A that includes a third device E3 between the first device E1 and the second device E2. The third device E3 may be provided when the focal distance between the first device E1 and the second device E2 is insufficient or difficult to determine. The third device E3 may include a third substrate 103, and an upper lens 181 and a lower lens 182 on an upper surface and a lower surface of the third substrate 103, respectively. A lens 181 may be between the first reflector 121 and the first grating coupler 131, and a lens 182 may be between the second reflector 122 and the second grating coupler 132. In an example embodiment, when the third device E3 is included in the semiconductor device 100A, the second device E2 may not include the lens 170.

The third substrate 103 may include third alignment structures 103A1 and 103A2 for aligning the first substrate 101 and the second substrate 102. The third alignment structures 103A1 and 103A2 may be on an upper surface and a lower surface of the third substrate 103, respectively, and may be aligned with the first alignment structure 101A and the second alignment structure 102A.

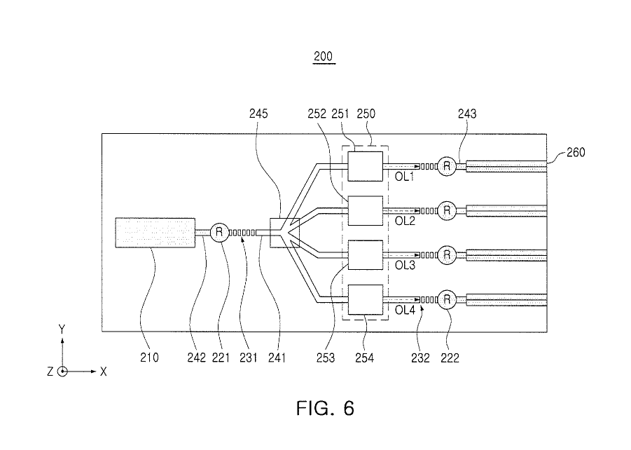

FIG. 6 illustrates an embodiment of a semiconductor device 200 which may include a light source 210, reflectors 221 and 222, an optical distributor 245, a light modulator 250, and an optical fiber 260. Waveguides 241 to 243 may be between components as described above to provide a light path. Unlike the semiconductor devices 100 and 100A of FIGS. 3 to 5, the semiconductor device 200 may include a single light source 210. Light output from the light source 210 may be divided into light of different wavelengths by the optical distributor 245. The divided light may be transmitted to a first light modulator 251, a second light modulator 252, a third light modulator 253, and a fourth light modulator 254.

With reference to FIG. 6, a path of light provided by a lower waveguide 241 may be changed from a single path of light into a plurality of paths in the optical distributor 245. In an example embodiment, the optical distributor 245 may divide light generated by the light source 210 into four types of light having different wavelengths for transmission to respective ones of the first light modulator 251, the second light modulator 252, the third light modulator 253, and the fourth light modulator 254. The first light modulator 251, the second light modulator 252, the third light modulator 253, and the fourth light modulator 254 may respectively generate the first optical signal OL1, the second optical signal OL2, the third optical signal OL3, and the fourth optical signal OL4, for example, by changing the intensity, the phase, and/or another parameter of the received light. The first optical signal OL1, the second optical signal OL2, the third optical signal OL3, and the fourth optical signal OL4 may be output through a plurality of corresponding optical fibers without interference or overlap therebetween.

In the example embodiment of FIG. 6, components 210, 221, 222, 242, 243, and 260 (marked by hatching) may be on a substrate different from a substrate which includes remaining components 231, 232, 241, 245, and 250 (not marked by hatching).

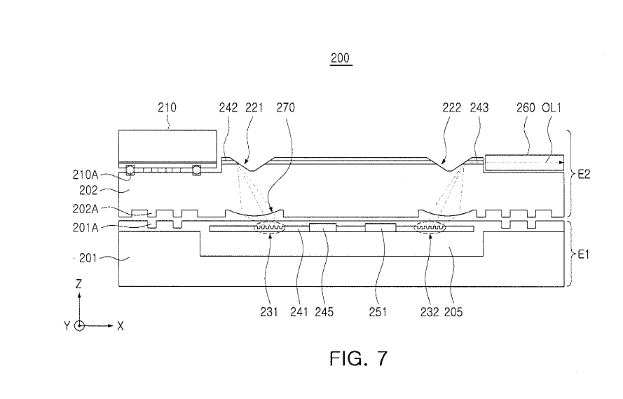

FIG. 7 illustrates a vertical cross-sectional view of the semiconductor device 200 along the path of the first optical signal OL1. With reference to FIG. 7, the semiconductor device 200 may include the second device E2 on the first device E1. The first device E1 may include a first substrate 201, a lower waveguide 241 on the first substrate 201, and an insulating layer 205 encapsulating the lower waveguide 241. A first grating coupler 231 and a second grating coupler 232 may be provided on opposing ends of the lower waveguide 241.

The second device E2 may include a second substrate 202, the light source 210 and the optical fiber 260 on the second substrate 202, and the reflectors 221 and 222 adjacent to the light source 210 and the optical fiber 260. Light generated in the light source 210 may be emitted to a first upper waveguide 242 and reflected by a first reflector 221 toward and incident on a lower waveguide 241 through the first grating coupler 231. In an example embodiment, a lens 270 between the first reflector 221 and the first grating coupler 231 may be on a lower surface of the second substrate 202.

Light emitted through the lower waveguide 241 may be divided into a plurality of wavelength bands by the optical distributor 245. The first light modulator 251 may receive light divided into a first wavelength band to generate a first optical signal OL1. The first optical signal OL1 may be output outwardly of the lower waveguide 241 through the second grating coupler 232 and may be reflected by a second reflector 222 toward and incident on the optical fiber 260 through a second upper waveguide 243.

As illustrated in FIG. 7, a first alignment structure 201A may be provided on the upper surface of the first substrate 201, and a second alignment structure 202A may be provided on the lower surface of the second substrate 202. The first device E1 may be combined with the second device E2 by aligning the first alignment structure 201A and the second alignment structure 202A. This allows the light transmission path between the first device E1 and the second device E2 to be precisely aligned.

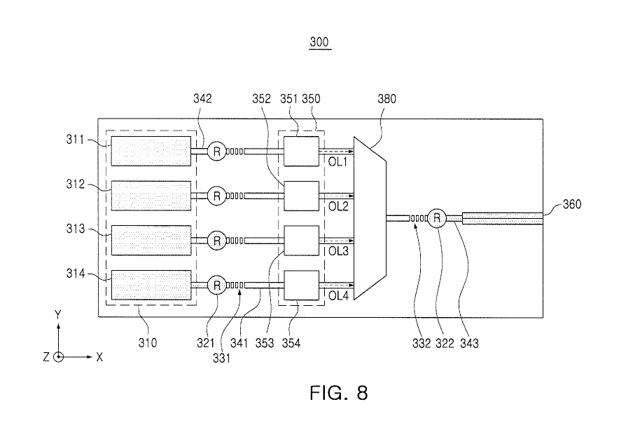

FIG. 8 illustrates another embodiment of a semiconductor device 300 which may include a light source 310, reflectors 321 and 322, a light modulator 350, an optical fiber 360, and a WDM device 380. Waveguides 341 to 343 may be between components as described above to provide a light path. The semiconductor device 300 may include a plurality of light sources 311 to 314 outputting light having different wavelengths. For example, the light source 310 may include a first light source 311, a second light source 312, a third light source 313, and a fourth light source 314 that generates light transmitted to a first light modulator 351, a second light modulator 352, a third light modulator 353, and a fourth light modulator 354, respectively.

A first optical signal OL1, second optical signal OL2, third optical signal OL3, and a fourth optical signal OL4 are respectively generated and output from the first light modulator 351, the second light modulator 352, the third light modulator 353, and the fourth light modulator 354 and may have different wavelengths. The WDM device 380 may generate an output optical signal OL using the first optical signal OL1, the second optical signal OL2, the third optical signal OL3, and the fourth optical signal OL4. In an example embodiment, the WDM device 380 may operate as a type of multiplexer.

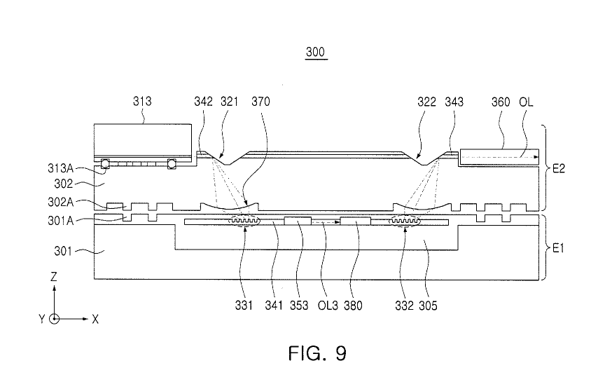

FIG. 9 illustrates a vertical cross-sectional view of the semiconductor device 300 along a path of a third optical signal OL3. With reference to FIG. 9, the semiconductor device 300 may include a second device E1 on a first device E2. The first device E1 may include a first substrate 301, a lower waveguide 341 on the first substrate 301, a WDM device 380, and an insulating layer 305. In an example embodiment, the lower waveguide 341 and WDM device 380 may be encapsulated in the insulating layer 305.

In FIG. 9, light generated by a third light source 313 may be in a third wavelength band. The light in the third wavelength band may be modulated by the third light modulator 353 to generate the third optical signal OL3, and the third optical signal OL3 may be transmitted to the WDM device 380. The WDM device 380 may generate the output optical signal OL by combining the third optical signal OL3 with one or more other optical signals OL1, OL2, and OL4. The output optical signal OL may be output outwardly through the optical fiber 360.

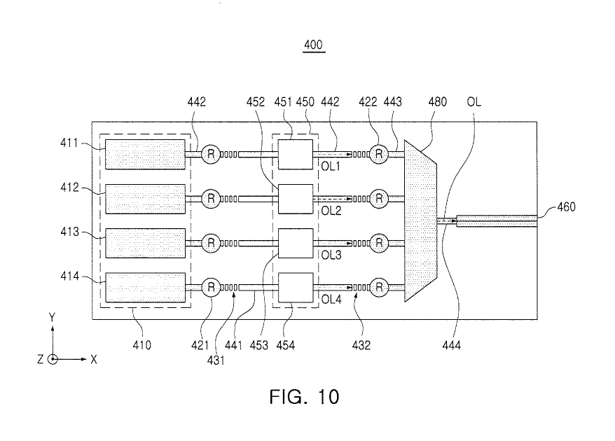

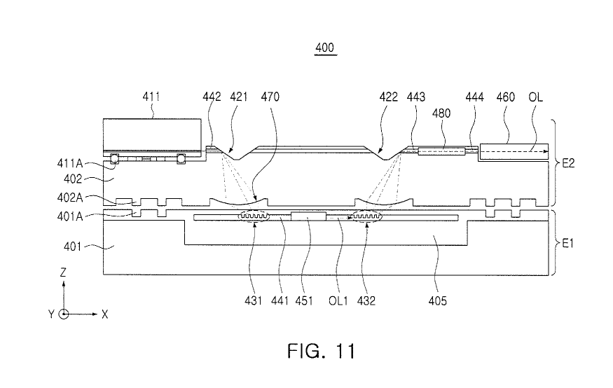

FIGS. 10 and 11 illustrate an embodiment of a semiconductor device 400 which may include a light source 410, reflectors 421 and 422, a light modulator 450, an optical fiber 460, and a WDM device 480. Waveguides 441 to 444 may be between components as described above to provide a light path. The semiconductor device 400 of FIGS. 10 and 11 may include a plurality of light sources 411 to 414 outputting light of different wavelengths. For example, the light source 410 may include a first light source 411, a second light source 412, a third light source 413, and a fourth light source 414 that respectively generate light to be transmitted to a first light modulator 451, a second light modulator 452, a third light modulator 453, and a fourth light modulator 454.

A first optical signal OL1, a second optical signal OL2, a third optical signal OL3, and a fourth optical signal OL4 respectively generated by and output from the first light modulator 451, the second light modulator 452, the third light modulator 453, and the fourth light modulator 454 may have different wavelengths. The WDM device 380 may operate as a multiplexer that generates an output optical signal OL based on the first optical signal OL1, the second optical signal OL2, the third optical signal OL3, and the fourth optical signal OL4.

FIG. 11 illustrates a vertical cross-sectional view of the semiconductor device 400 along a path for a first optical signal OL1. With reference to FIG. 11, the semiconductor device 400 may include a second device E1 on a first device E2. The first device E1 may include a first substrate 401, a lower waveguide 441 on the first substrate 401, and an insulating layer 405.

In the example embodiment of FIG. 11, the WDM device 480 may be in a second substrate 402. The first optical signal OL1 generated by the first light modulator 451 may be transmitted to the WDM device 480 through a second grating coupler 432 and a second reflector 422. The WDM device 480 may combine the first optical signal OL1 and optical signals OL2 to OL4 to generate the output optical signal OL.

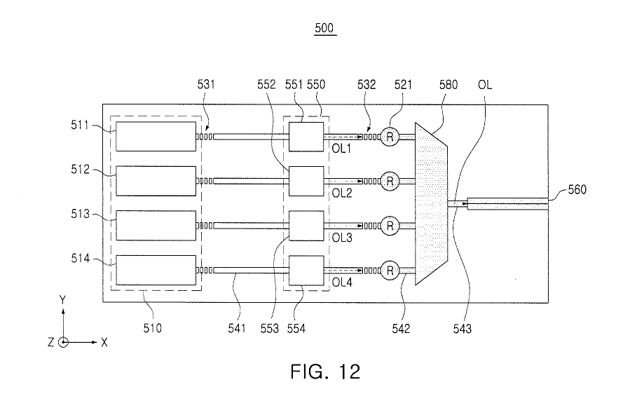

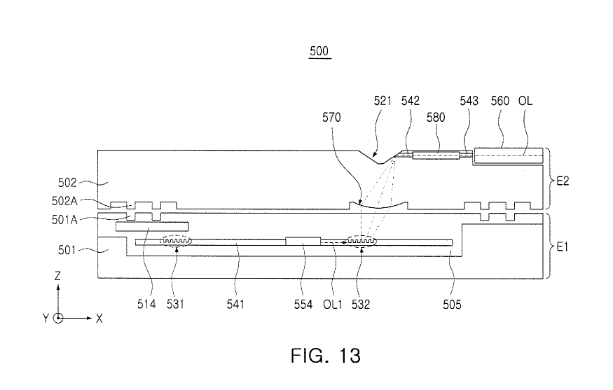

FIGS. 12 and 13 illustrates an embodiment of a semiconductor device 500 which may include a light source 510, a reflector 521, a light modulator 550, an optical fiber 560, and a WDM device 521. In the example embodiment of FIGS. 12 and 13, overall components such as the light source 510, the light modulator 550, etc., except for the WDM device 580 and the optical fiber 560, may be in a first device E1.

A first light source 511, a second light source 512, a third light source 513, and a fourth light source 514 may be coupled to a lower waveguide 541 through a first grating coupler 531. With reference to FIG. 13, which illustrates a vertical cross-sectional structure of the semiconductor device 500, an entirety of the first light source 511 and the lower waveguide 541 may be encapsulated in an insulating layer 505 on a first substrate 501. In a manner different from the example embodiment illustrated in FIG. 13, in a case in which the first light source 511, the second light source 512, the third light source 513, and the fourth light source 514 output light laterally, the first light source 511, the second light source 512, the third light source 513, and the fourth light source 514 may be coupled without the lower waveguide 541 and the first grating coupler 531.

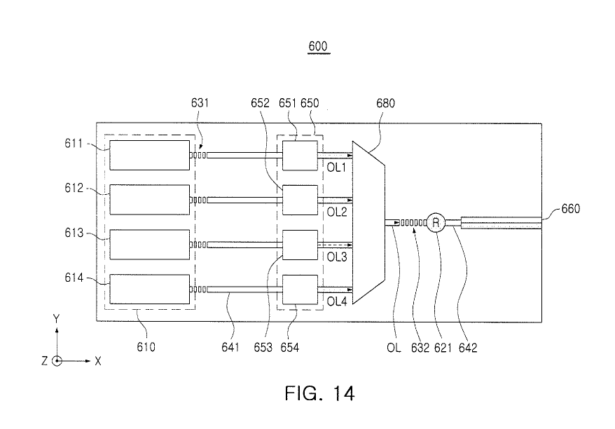

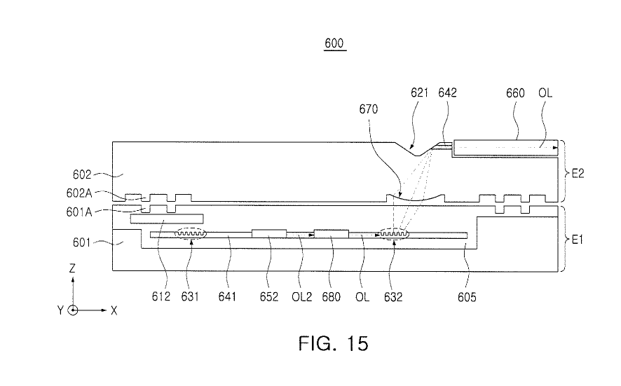

FIGS. 14 and 15 illustrate an embodiment of a semiconductor device 600 which may include a light source 610, a reflector 621, a light modulator 650, an optical fiber 660, and a WDM device 680. In the example embodiment of FIGS. 14 and 15, an entirety of components such as a light source 610, a light modulator 650, a WDM device 680, etc., except for an optical fiber 660 and a waveguide 642, may be in the first device E1. As illustrated in FIG. 15, a first light source 611, a second light source 612, a third light source 613, and a fourth light source 614 may be coupled to a lower waveguide 641 through a first grating coupler 631. In a manner different from the example embodiment of FIG. 15, in a case in which the first light source 611, the second light source 612, the third light source 613, and the fourth light source 614 laterally output light, the first light source 611, the second light source 612, the third light source 613, and the fourth light source 614 may be coupled without the lower waveguide 641 and the first grating coupler 631.

In additional embodiments, a third device E3, for example, according to the example embodiment of FIG. 5 may be applied to the semiconductor devices 200 to 600 of FIGS. 6 to 15. The third device E3 may be interposed between the first device E1 and the second device E2, for example, when there is concern about a problem in transmitting an optical signal according to focal distance in the semiconductor devices 200 to 600.

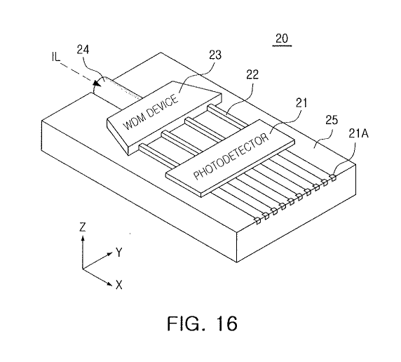

FIG. 16 illustrates another embodiment of a semiconductor device 20 which may serve as an optical signal receiving device for receiving an optical signal to be converted to an electrical signal. The semiconductor device 20 may include a photodetector 21, a WDM device 23, and an optical fiber 24. A waveguide 22 may be between components to provide a light path. In an example embodiment, at least a portion of the photodetector 21, the waveguide 22, the WDM device 23, and the optical fiber 24 may be encapsulated by an insulating layer on a substrate 25.

The optical signal received through the optical fiber 24 may be divided by the WDM device 23 into a plurality of optical signals of different wavelengths. The optical signals of different wavelengths may be transmitted to the photodetector 21 through different waveguides 22. The photodetector 21 may convert respective optical signals to electrical signals. The electrical signals generated by the photodetector 21 may be output outwardly through respective pads 21A. In an example embodiment, the pads 21A may be coupled to an integrated circuit (IC) chip that receives the electrical signals to perform a certain operation.

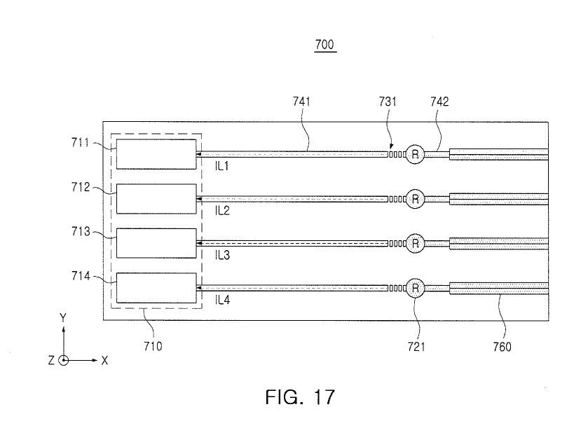

FIGS. 17 to 22 illustrate additional embodiments of a semiconductor device.

FIG. 17 illustrates an embodiment of a semiconductor device 700 which may include a photodetector 710, a reflector 721, and an optical fiber 760. Waveguides 741 and 742 may be between adjacent ones of the photodetector 710, the reflector 721, and the optical fiber 760 in order to provide paths for optical signals IL1 to IL4. The photodetector 710 may include a first photodetector 711, a second photodetector 712, a third photodetector 713, and a fourth photodetector 714 which receive a first optical signal IL1, a second optical signal IL2, a third optical signal IL3, and a fourth optical signal IL4, respectively, having different wavelengths. Electrical signals generated by the first photodetector 711, the second photodetector 712, the third photodetector 713, and the fourth photodetector 714 may be different from each other.

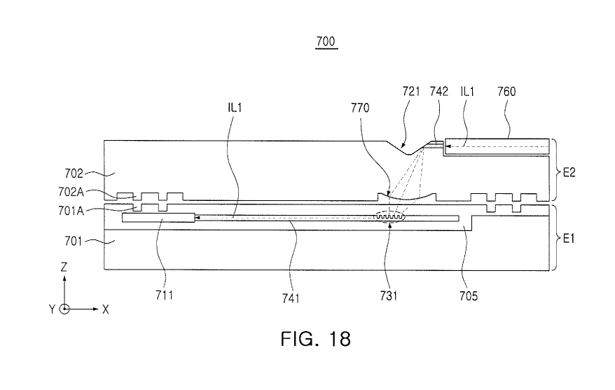

FIG. 18 illustrates a vertical cross-sectional structure of the semiconductor device 700 along a path of the first optical signal IL1. With reference to FIG. 18, the semiconductor device 700 may include a second device E2 on a first device E1. The first device E1 may include a first substrate 701, a lower waveguide 741, a first photodetector 711, and an insulating layer 705 encapsulating the lower waveguide 741 and the first photodetector 711. A grating coupler 731 may be on a side of the lower waveguide 741.

The second device E2 may include a second substrate 702, an optical fiber 760, and a reflector 722. The first optical signal IL1 received by the optical fiber 760 may be reflected by the reflector 722 and emitted to the lower waveguide 741 through the grating coupler 731. A lens 770 may be on a lower surface of the second substrate 702, so that the first optical signal IL1 reflected by the reflector 722 may be concentrated on the grating coupler 731.

With reference to FIG. 18, a first alignment structure 701A may be on an upper surface of the first substrate 701, and a second alignment structure 702A may be on the lower surface of the second substrate 702. The first device E1 may be combined with the second device E2 by aligning the first alignment structure 701A and the second alignment structure 702A. As a result, a transmission path of optical signals IL1 to IL4 between the first device E1 and the second device E2 may be accurately aligned.

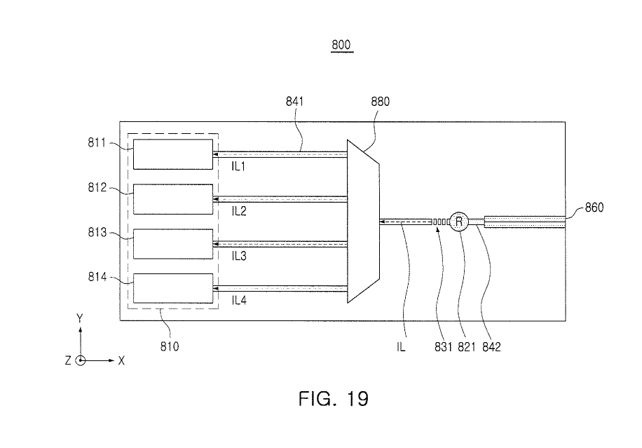

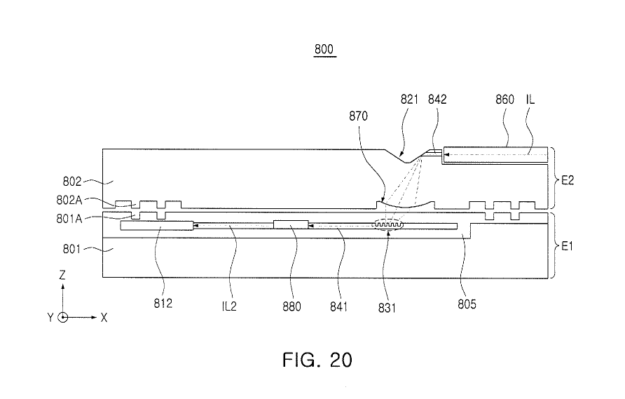

FIGS. 19 and 20 illustrate another embodiment of a semiconductor device 800 which may include a photodetector 810, a reflector 821, an optical fiber 860, and a WDM device 880. The WDM device 880 may divide a received optical signal IL transmitted through the optical fiber 860 into optical signals IL1 to IL4 having a plurality of wavelengths for transmission to respective photodetectors 811 to 814. A first photodetector 811, a second photodetector 812, a third photodetector 813, and a fourth photodetector 814 may generate electrical signals based on respective ones of the first optical signal ILL the second optical signal IL2, the third optical signal IL3, and the fourth optical signal IL4, having different wavelengths, from the WDM device 880.

The WDM device 880 may be in the first device E1 and may be encapsulated in an insulating layer 805. The WDM device 880 may receive the received optical signal IL through a grating coupler 831 on a side of a waveguide 841. Since the received optical signal IL is divided, according to wavelength, to generate the first optical signal ILL the second optical signal IL2, the third optical signal IL3, and the fourth optical signal IL4, the WDM device 880 may operate as a demultiplexer.

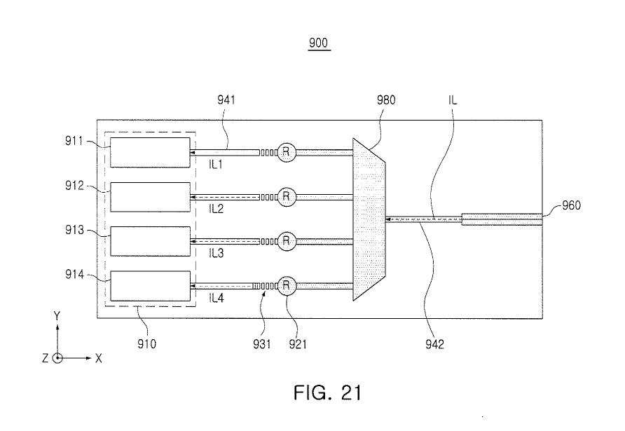

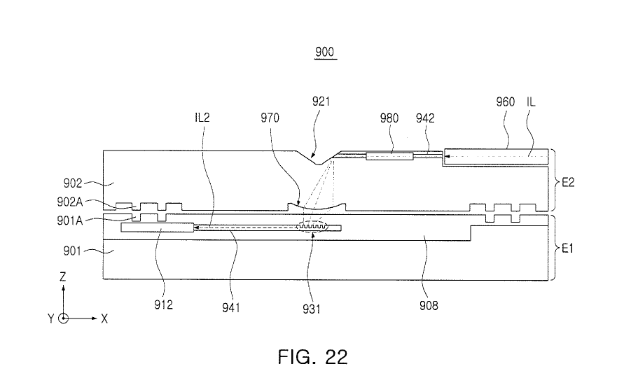

FIGS. 21 and 22 illustrate another embodiment of a semiconductor device 900 which may include a photodetector 910, a reflector 921, an optical fiber 960, and a WDM device 980. The example embodiment of FIGS. 21 and 22 may be different from the example embodiment of FIGS. 19 and 20 in that the WDM device 980 may be in the second device E2.

With reference to FIGS. 21 and 22, a photodetector 910 and a lower waveguide 941 having a grating coupler 931 may be in the first device E1, and an optical fiber 960, an upper waveguide 942, and a WDM device 980 may be in the second device E2. The WDM device 980 may divide the received optical signal IL into the first optical signal ILL the second optical signal IL2, the third optical signal IL3, and the fourth optical signal IL4, having different wavelengths and, thus, may operate as a demultiplexer.

The semiconductor devices 700 to 900 of FIGS. 17 to 22 have been described as including the first device E1 and the second device E2. In other embodiments, when, for example, there is a concern about a problem in transmitting the received optical signal IL according to focal distance in the semiconductor devices 700 to 900, a third device may be added between the first device E1 and the second device E2 of the semiconductor devices 700 to 900. The third device added between the first device E1 and the second device E2 may include a lens, for example, in the same manner as the example embodiment of FIG. 5.

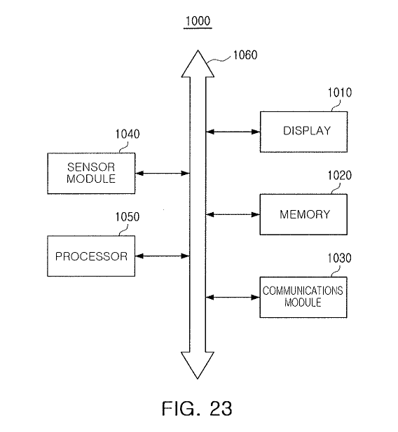

FIG. 23 illustrates an embodiment of an electronic device 1000 which may include a display 1010, a memory 1020, a communications module 1030, a sensor module 1040, and a processor 1050. The electronic device 1000 may be, for example, a television, a desktop computer, a smartphone, a tablet PC, a laptop computer, or another electronic device. A display 1010, a memory 1020, a communications module 1030, a sensor module 1040, a processor 1050, and/or other components may communicate with each other via a bus 1060.

The components in the electronic device 1000 may communicate with each other by exchanging one or more optical signals. A driving device of the display 1010, the memory 1020, the communications module 1030, the sensor module 1040, and the processor 1050 may include, for example, one or more of semiconductor devices 10, 20, and 100 to 900.

In accordance with one or more of the aforementioned embodiments, a semiconductor device includes an optical fiber and a waveguide on different substrates. The optical fiber may be coupled to the waveguide in a precisely aligned manner by aligning alignment structures on the substrates. As a result, aligning the substrates may be simplified and performed at lower cost. Also, the cost and complexity of a test process for the semiconductor device may be improved. In one or more embodiments, a reflector may be adjacent to the optical fiber. In addition, various other components may easily be added to the semiconductor device, thereby improving scalability.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, various changes in form and details may be made without departing from the spirit and scope of the embodiments set forth in the claims.

What is claimed is:

1. A semiconductor device, comprising:
a first device including at least one waveguide on a first substrate; and
a second device on the first device and including at least one optical fiber on an upper surface of a second substrate, a reflector on the upper surface of the second substrate, and a lens on a lower surface of the second substrate below the reflector, the at least one waveguide to carry light from the reflector and passing through the lens.

2. The semiconductor device as claimed in claim 1, wherein at least one of the first device and the second device includes an optoelectronic device.

3. The semiconductor device as claimed in claim 1, wherein:
the at least one waveguide includes a plurality of waveguides, and
the plurality of waveguides provide respective transmission paths for optical signals of different wavelengths.

4. The semiconductor device as claimed in claim 3, wherein at least one of the first device and the second device includes a wavelength division multiplexing (WDM) device connected between the at least one optical fiber and the plurality of waveguides.

5. The semiconductor device as claimed in claim 4, wherein the WDM device includes at least one of a WDM multiplexer to generate an output optical signal based on the optical signals transmitted through the plurality of waveguides, the output optical signal to be output to the optical fiber, and a WDM demultiplexer to generate the optical signals of different wavelengths based on an input optical signal transmitted through the at least one optical fiber.

6. The semiconductor device as claimed in claim 4, wherein:
the at least one optical fiber corresponds to a number of optical fibers, and
the number of optical fibers is less than a number of the plurality of waveguides.

7. The semiconductor device as claimed in claim 1, further comprising:
a third device between the first device and the second device.

8. The semiconductor device as claimed in claim 7, wherein the third device includes a third substrate, an upper lens on an upper surface of the third substrate, and a lower lens on a lower surface of the third substrate.

9. The semiconductor device as claimed in claim 1, wherein the waveguide includes a grating coupler below the reflector.

10. The semiconductor device as claimed in claim 1, wherein:
the first device includes a first alignment structure on an upper surface of the first substrate, and
the second device includes a second alignment structure on the lower surface of the second substrate, the second alignment structure aligned with the first alignment structure.

11. A semiconductor device, comprising:
a light source to emit light;
at least one light modulator to generate an optical signal based on light emitted by the light source;
at least one waveguide, connected to the at least one light modulator, to provide a path for the optical signal;
an optical fiber to output the optical signal; and
a reflector to reflect the optical signal emitted along the at least one waveguide for input into the optical fiber, wherein the at least one light modulator and the at least one waveguide are on a first substrate and wherein the optical fiber and the reflector are on a second substrate different from the first substrate.

12. The semiconductor device as claimed in claim 11, wherein the at least one waveguide includes a first grating coupler to receive light emitted by the light source and a second grating coupler to transmit the optical signal to the reflector.

13. The semiconductor device as claimed in claim 12, further comprising:
a lens between the second grating coupler and the reflector.

14. The semiconductor device as claimed in claim 11, wherein:
the at least one light modulator includes a plurality of light modulators to generate respective optical signals of different wavelengths, and
the at least one waveguide includes a plurality of waveguides providing paths for respective ones of the optical signals of different wavelengths.

15. The semiconductor device as claimed in claim 14, further comprising:
a WDM multiplexer connected between the plurality of waveguides and the optical fiber.

16. The semiconductor device as claimed in claim 14, wherein the light source includes a plurality of light sources to generate light of different wavelengths.

17. The semiconductor device as claimed in claim 14, further comprising:
an optical distributor to reflect light emitted by the light source toward the plurality of waveguides.

18. A semiconductor device, comprising:
an optical fiber to receive an optical signal;
a reflector to reflect the optical signal emitted through the optical fiber;
at least one waveguide to receive the optical signal reflected by the reflector and provide a path for the optical signal; and
a photodetector, connected to the at least one waveguide, to convert the optical signal to an electrical signal, wherein the photodetector and the at least one waveguide are on a first substrate and wherein the optical fiber and the reflector are on a second substrate different from the first substrate.

19. The semiconductor device as claimed in claim 18, further comprising:
a WDM demultiplexer to divide the optical signal into a plurality of optical signals of different wavelengths.

20. The semiconductor device as claimed in claim 19, wherein:
the at least one waveguide includes a plurality of waveguides providing respective paths for the plurality of optical signals of different wavelengths, and
the WDM demultiplexer is connected between the optical fiber and the plurality of waveguides.
